(19) United States
(12) Patent Application Publication
(10) Pub. No.: US 2003/0018663 A1
(43) Pub. Date: Jan. 23, 2003

(54) Method and system for creating a multimedia electronic book

(76) Inventors: Ranjita K. Cornette, Silver Spring, MD (US); David Jimison, Pittsburgh, PA (US); Mary D.L. Cutting, Washington, DC (US); James H.B. Cutting, Washington, DC (US)

Correspondence Address: BLACK LOWE & GRAHAM, 816 Second Avenue, Seattle, WA, 98104, US

(21) Appl. No.: 10/158,407

(22) Filed: May 29, 2002

Related U.S. Application Data
(60) Provisional application No. 60/294,449, filed on May 30, 2001.

(51) Int. Cl. G09G 5/12

(52) U.S. Cl. 707/500.1

(57) ABSTRACT

A multimedia electronic book is created. Information, typically text, is taken and broken up into specific components, such as without limitation chapters or important definitions and glossary terms, geographical locations, and references that will have multimedia integration. These components are developed and created, and suitably may be linked together in a linear synchronized fashion or a non-linear indexed fashion or both. Medium(s) are analyzed, and the most appropriate playing formats are determined. Examples of typical playing formats may include without limitation Real Audio Player, Windows Media Player, MP3, QuickTime, Flash Project, Microsoft Internet Explorer or other available software. The completed product is transferred to a portable storage medium or to a server for future download.

### PRIORITY CLAIM

This application claims priority from Provisional Application filed May 30, 2001, Serial No. 60/294,449.

### FIELD OF THE INVENTION

This invention relates generally to portable electronic devices and, more particularly, to portable multimedia electronic books.

### BACKGROUND OF THE INVENTION

The publishing industry is at the doorstep of the biggest change in publishing since the invention of the printing press—the electronic book. Electronic books, also known as e-books, are a digitized version of a printed book—s text, graphics and photographs. Though the shift to a non-print environment has been occurring steadily, advances in electronic reading devices promise to accelerate this trend. Electronic readers now feature paper-thin screens that can be turned like pages and can hold several volumes. Print size is adjustable to suit the reader and books can be downloaded directly from the World Wide Web to any computer, from a desktop, to a personal digital assistant (“PDA”), and at a cost lower than the print version.

Current e-books, however, have proven problematic in that they are linear in nature, as they only contain digitized text that has been typed in manually and some graphics, which can be displayed on a computer equipped with suitable software of a dedicated e-book device. Other features, such as a glossary or images relating to certain content, although provided, are not linked with each other so as to create a more pleasurable experience for the reader. In addition, neither animations nor other multimedia content is currently implemented because no suitable process of creating a multimedia-filled e-book supporting portable electronic devices has been created. While a personal computer (“PC”) can support an e-book filled with various multimedia components, portable devices such as PDAs cannot, due to the lack of processing power and memory constraints. At present, there are no known portable hardware devices available that can manage a high level of content, i.e. multimedia data which includes video animation, music, voice recognition, speech, 3D graphics, text animation, internet linkage, etc., in a synchronous fashion.

Thus, there is an unmet need in the art for a portable, multimedia electronic book.

### SUMMARY OF THE INVENTION

The present invention provides a method and system for creating a multimedia electronic book for use on various computer devices including portable electronic devices. The present invention also provides a multimedia electronic book which improves upon the problems associated with current electronic books.

A process for creating a multimedia electronic book in accordance with one embodiment of the present invention allows any common software package, such as without limitation Adobe Photoshop, Adobe Streamline, Macromedia Flash, Macromedia Director, Sonic Foundry's Sound Forge, Windows Media, Adobe Acrobat, and various programming languages, including, but not limited to XML, Javascript, Java and Visual Basic, to be used in a desired combination resulting in the multimedia electronic book. The result is a product which is different from present e-books, because an embodiment of the multimedia electronic book suitably includes the synchronization of audio, animated text (features highlighting), as well as any current or developing technologies such as 3D video and graphics (still and animation). The multimedia electronic book of the present invention is an immersive experience allowing the user to read an electronic book in a non-linear fashion.

According to a presently preferred embodiment of the present invention, components of the multimedia electronic book are suitably linkable, enabling features to cross-reference each other while providing a seamless experience to the reader. In one embodiment, all components are linkable. However, it is not necessary for all components to be linkable. These linkable features may include, but are not limited to, references such as a glossary for looking up definitions, maps to illustrate location, music and speech libraries, virtual tours to illustrate scenery, and community rich sites on the World Wide Web. Additionally, a user can personalize the multimedia electronic book by changing features of the content. Promotions targeted to readers based on their demographic may be accessed at appropriate read times. This feature can be implemented, if desired, by utilizing GPS systems, for example. Although a multimedia electronic book in accordance with the present invention can run on a PC, Macintosh, or other non-portable computer, a presently preferred embodiment is primarily intended for portable computing devices.

According to one aspect of the present invention, a method is provided for creating a multimedia electronic book. Information, typically text, is taken and broken up into specific components, such as without limitation chapters or important definitions and glossary terms, geographical locations, and references that will have multimedia integration. These components are developed and created, and suitably may be linked together in a linear synchronized fashion or a non-linear indexed fashion or both. Medium(s) are analyzed, and the most appropriate playing formats are determined. Examples of typical playing formats may include Real Audio Player, Windows Media Player, MP3, QuickTime, Flash Project, Microsoft Internet Explorer or other available software. The completed product is transferred to a portable storage medium or to a server for future download.

In accordance with another aspect of the present invention, a system for creating a multimedia electronic book is provided. The system includes an input device for transferring the information, typically text, to a computer. The computer, which typically includes a processor and a memory, breaks up the information into specific components. The computer suitably includes standard software packages installed in its memory for processing the information and generating the components. The system also includes an encoder for encoding the multimedia components into desirable playing format(s), such as without limitation Windows Media, Flash Projector, MP3, MP4, and/or AVI, and transferring means, such as a disk drive or network interface, for transferring the multimedia electronic book to a portable storage medium or a server for future download. The system may optionally include a voice recognition module for enabling users to dictate into the multimedia electronic book, and navigate the multimedia electronic book material via voice, thereby customizing the book to the user's needs.

In accordance with another aspect of the present invention, a multimedia electronic book is provided. The multimedia electronic book includes multimedia components linked to each other through reference points. Multimedia components can include text animation, highlighting, video, 3D graphics, still images, music, speech, links to the World Wide Web, or other features which can provide an enhanced experience for the reader. The multimedia electronic book may further include a glossary linked to the text, maps where appropriate, music, speech libraries, or promotions linked to appropriate trigger points in the text.

### BRIEF DESCRIPTION OF THE DRAWINGS

The above, as well as further features of the invention and advantages thereof, will be apparent in the following detailed description of certain advantageous embodiments which is to be read in connection with the accompanying drawings forming a part hereof, and wherein corresponding parts and components are identified by the same reference numerals in the several views of the drawings.

In the accompanying drawings:

FIG. 1 is a flowchart of a method for creating a multimedia electronic book;

FIG. 2 is a block diagram of components of a multimedia electronic book;

FIGS. 2-7 are exemplary images from a typical multimedia electronic book; and

FIG. 8 is a block diagram of an exemplary host environment of a system for creating a multimedia electronic book.

### DETAILED DESCRIPTION OF THE INVENTION

By way of overview, a multimedia electronic book is created according to one embodiment of the present invention. Information, typically text, is taken and broken up into specific components, such as without limitation chapters or important definitions and glossary terms, geographical locations, and references that will have multimedia integration. These components are developed and created, and suitably may be linked together in a linear synchronized fashion or a non-linear indexed fashion or both. Medium(s) are analyzed, and the most appropriate playing formats are determined. Examples of typical playing formats may include without limitation Real Audio Player, Windows Media Player, MP3, QuickTime, Flash Project, Microsoft Internet Explorer or other available software. The completed product is transferred to a portable storage medium or to a server for future download.

Exemplary Method of Creating Multimedia Electronic Book

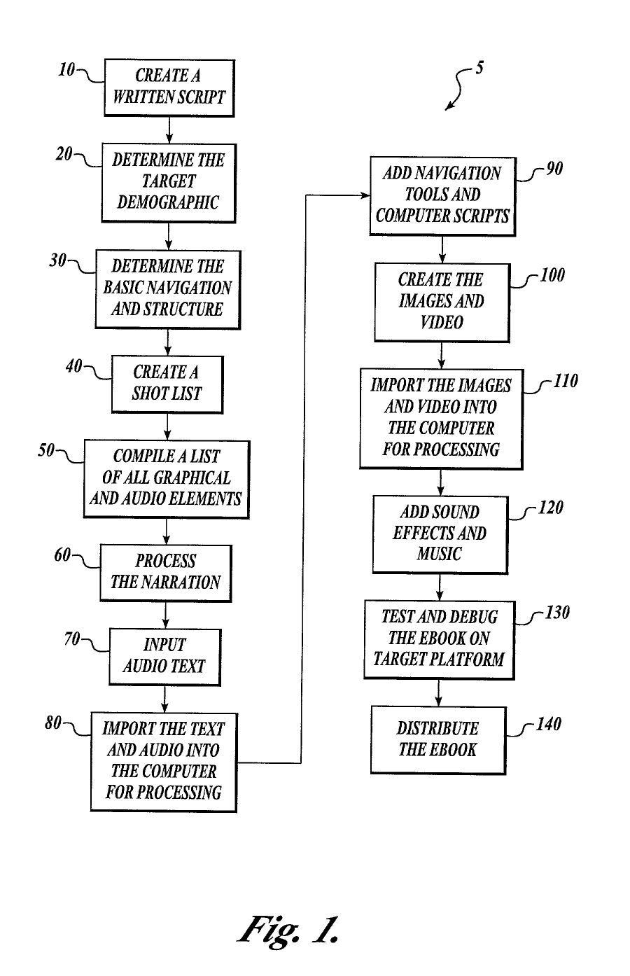

Referring now to FIG. 1, in one presently preferred embodiment a method 5 for creating a multimedia electronic book begins at a block 10 where a written script for the material is created. The script may include text of the book, narration for navigation of the book, descriptions of visual elements of the book, or any other text which is to be included with the book, as desired.

At a block 20, a determination is made regarding a target demographic for the book, i.e. desirable devices on which the book may be played. In addition, a method of transfer of information to the viewer is determined, such as by World Wide Web, CD-ROM, pocket PC, or other method. An intended method of generating and collecting revenue from the multimedia electronic book is also established, such as without limitation advertising, subscription fees, pay per download/purchase, or time-based fees. Alternately, some material may be commissioned by governments, corporations, etc., and may be available to the public for free.

With this information, the basic navigation and structure of the book is decided upon at a block 30. The text is broken into specific components, such as without limitation, chapters, definitions, glossary terms, geographical locations, or references that will have multimedia integration as desired. As one example, a column is created containing image reference points, audio descriptions, and navigation points. Lists are made of desired material. While there can also exist separate scripts for different elements of the book, there is one overall script which organizes all of the material. At a block 40, a shot list (sketch) is sketched on paper, denoting visual elements that will correspond with the text. If there are to be sound effects, the sound effects are added to the shot list and script at this stage as well. At a block 50, a list is compiled of all desirable graphical and audio elements, that is the visual elements and the sound effects corresponding with the text, for the multimedia electronic book.

At a block 60, narration is recorded, edited, compressed, encoded, and equalized using appropriate software, such as without limitation Steinberg Wavelab and Sonic Foundry Sound Forge. Compression rates are selected based on the platform. For example, web based audio requiring high-level protection might be encrypted in one format, such as without limitation Windows Media. Video, which has to be accessible to a group of customers with different bandwidth capabilities, may be encoded into a scalable platform, such as MP4. Alternatively, a dedicated hardware encoder can be used for faster processing if desired.

At a block 70, the text of the book is suitably typed in manually or imported from an electronic text source. The text and the audio are then imported into the computer's editing program and manually synched together at a block 80. This establishes a basic timeline for the multimedia electronic book. The components suitably may be linked together in a linear synchronized fashion or a non-linear indexed fashion or both. A multimedia electronic book with linear synchronization has one element lead into another from the first element to the last, and the user would have a defined experience of the material. An example of such is a fiction novel, where the elements, graphics, video, etc., must be experienced in accordance with plot point. For example, linear synchronized linking includes a narrative audio track that plays concurrently with highlighting text. The non-linear synchronization of a multimedia electronic book is analogous to a web, where each point (or element) is linked to several, or all, others. In this version, the user's experience is completely based upon their interests and direction. A non-limiting example of non-linear material is a textbook, which provides problems, lessons, equations, and the like, based upon the user's skill level and aptitude. According to the invention, the “creators” of the multimedia electronic book determine which material or components are accessible to the user at that point, or region, within the material. This could vary from “Next Page” to the entire World Wide Web. A non-limiting example of non-linear indexed linking includes a drag and drop system, where the user decides certain controlling elements for the plot line such as a main character, genre of the story, time period, or the like. The editing program to be used depends on the medium on which the multimedia electronic book will be distributed. For example, for a World Wide Web or pocket PC application, Macromedia's Flash is preferred and for CD-ROM production Macromedia Director is favored, although video editors such as Adobe Premiere are suitably used in conjunction with Adobe AfterEffects if the multimedia electronic book has many video components.

At a block 90, navigation tools and computer scripts are written and added to the multimedia electronic book depending on the software. Navigation tools consist of anything that allows the user to move from one element of the multimedia electronic book to another. It can consist of, but is not limited to, voice commands, clicking buttons or highlighted text, or manipulating any other controller such as a keyboard, joystick, or virtual space controller. Example of a virtual space controller is any device, which employs physical movement for navigation. This can range from GPS location devices to a virtual reality booth to eyepieces which track and react to eye movement. The computer scripts added to the multimedia electronic book enable third party material to be used within the multimedia electronic book. At this point, navigation of the multimedia electronic book will be possible and a “bare bones” version will exist.

At a block 100, visual elements are created. Images are scanned in or created on the computer. Vector images are suitably created using Adobe Illustrator, Macromedia Flash or other suitable graphics software. Raster images are suitably created with Adobe Photoshop, Macromedia Fireworks, Macromedia Flash or other graphics editing software. At the block 100, raster images are converted into vector graphics. The conversion can be implemented using Adobe Streamline or other suitable graphics conversion software. Video can be imported with a video card, such as without limitation a Matrox G550 video card, or any video encoder and then compressed and encoded using Terran Media Cleaner Pro or other suitable graphics compression software. Photos or other art can be scanned in with AGFA Duoscan, or any digital scanner or camera and color balanced, cropped, and prepared with Adobe Photoshop, or any digital imaging software.

The visual elements created at the block 100 are imported into the editing software and synched with the text and narration at a block 110. Any additional animations, fades or special effects are added. At a block 120, sound effects and music are added to the multimedia electronic book.

At a block 130, the entire multimedia electronic book is tested on the desired platform. Any fixes are made if desired. At a block 140, the multimedia electronic book is readied for distribution, such as, without limitation, by being placed on CD-ROM or some other storage device such as a PDA or pocket PC, or by being uploaded to an Internet or intranet computer.

Those of ordinary skill in the art will appreciate the versatility of the present invention. For example, the above-mentioned steps can be performed in any order as long as the dependent steps follow each other in a logical order.

Exemplary Multimedia Electronic Book

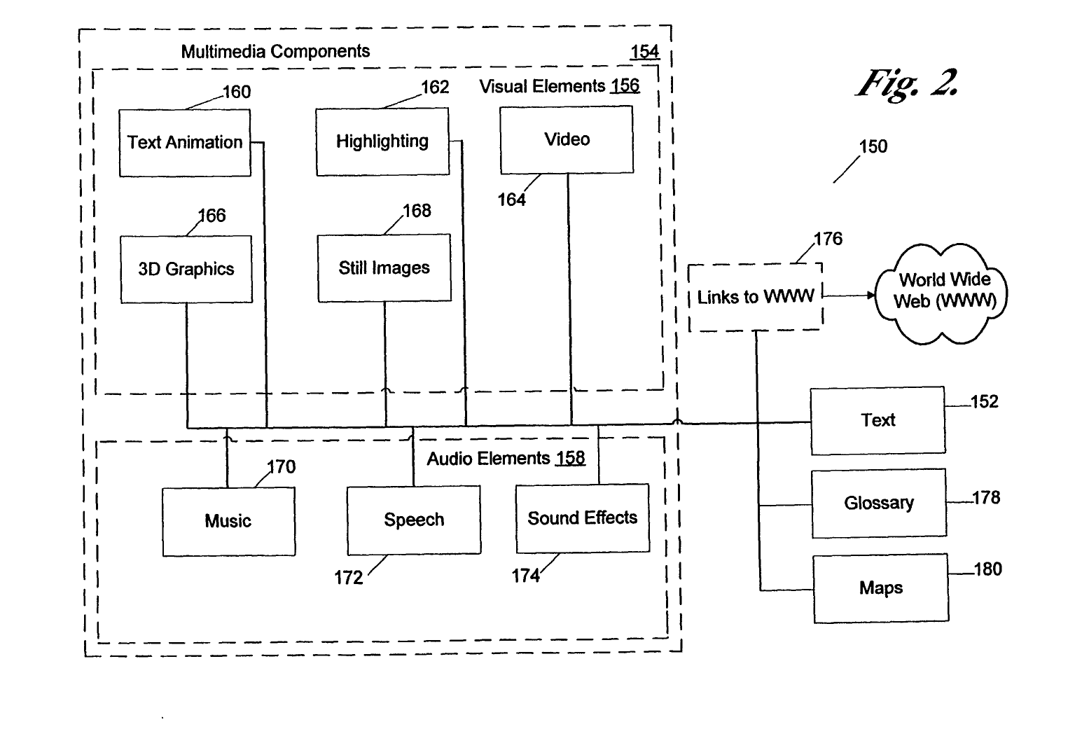

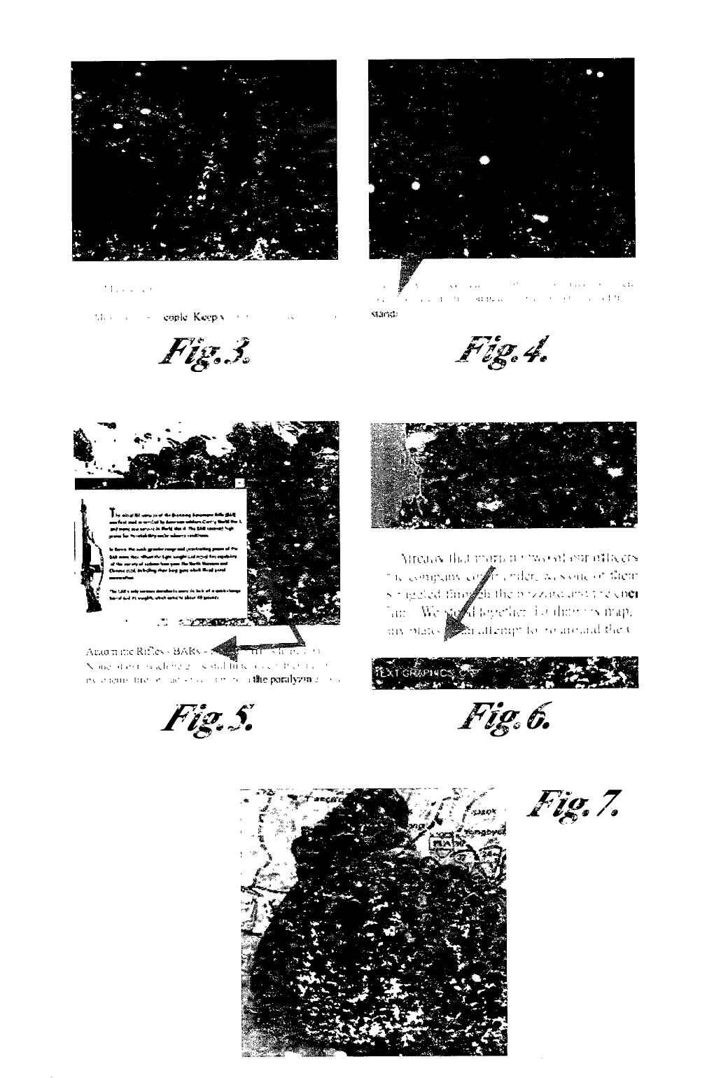

FIG. 2 is a block diagram of information components of an exemplary multimedia electronic book 150. In one presently preferred embodiment, the multimedia electronic book 150 includes text 152 and multimedia components 154 that are linked to each other and to appropriate trigger points in the text 152.

The multimedia components 154 suitably include visual elements 156 and audio elements 158. The visual elements 156 may include text animation 160, highlighting 162, video 164, 3D graphics 166, and still images 168. The audio elements 158 may include music 170, speech 172, and sound effects 174. The multimedia components 154 are suitably files created and stored in any acceptable file format.

If desired, other features may be linked to the text 152 and the multimedia components 154. For example, the multimedia electronic book 150 may include links 176 to the World Wide Web. A glossary 178 and maps 180 may be linked to appropriate trigger points in the text.

Implementation of an Exemplary Demonstration

Multimedia Electronic Book “Colder Than Hell”

The following example of creation of a multimedia electronic book for demonstration purposes is provided for clarification purposes only and is not intended to limit the scope of the invention.

To save on production costs, the sample of the book was chosen between 1-3 minutes long. A contributing factor was that a pocket PC platform was chosen for the demonstration. The constraints of the chip size also contributed to the decision of the length of the program. The audiobook had been previously recorded by The Cutting Corporation. A passage from the introductory chapter was selected, then edited with Sonic Foundry's Sound Forge and encoded into MP3 format using Steinberg Wavelab. Macromedia Flash was selected as the editing program for the multimedia electronic book, because it outputs the product in a suitable format for both the World Wide Web and CD-ROM.

The audio was input into Macromedia Flash, and the text was typed into the corresponding frames. Tweens (transitional graphics) were created so that the text would scroll at the appropriate pace. A highlighting mask was created, giving the text the appearance of becoming darker as it is read. This process allows the reader to follow along with the text as it is being read. It is helpful for people with reading disabilities.

Public domain photographs taken from the Korean War were found at several research sites on the Internet and were downloaded. These images were cropped, colored, and embellished with Adobe Photoshop. Some of the images were converted into vector graphics for use in the animation.

Macromedia Flash was used to create the vector animations, which were then synched to the text and audio. A music bed was selected and added to the beginning of the narration. Sound Effects were encoded using Sonic Foundry Sound Forge, and then mixed together using Sonic Foundry Acid. These sounds were then input into Macromedia Flash.

The product was reviewed and revised. Then it was output onto CD-ROM. Some of the animations were removed, and the audio was further compressed, in order to create a faster-loading and less-demanding version of the multimedia electronic book. This version was then loaded onto the Hewlett Packard Jornada, which is a typical PDA.

FIGS. 3-7 provide exemplary print-screen images of the multimedia electronic book produced through the process described above. Although not shown, the narration voice reads through the text and the highlighted text moves along with the speech. As shown in FIGS. 3 and 4, text scrolls up as it is being read, so that whatever has been read disappears from the screen. The user has the option of proceeding to different chapters at any time. FIG. 5 illustrates the option of looking up unknown terms in the glossary or dictionary linked to the text. A window with an explanation pops up if the user clicks on or otherwise selects the unknown term. As shown in FIG. 6, visibility of graphics, animation, and text can be turned off and only the narration can be heard, if desired. As shown in FIG. 7, images are animated as they change from one image to another image, e.g. the map changing to the photograph.

Exemplary Host Environment

FIGS. 1-7 are flowchart and screen shot illustrations of methods and computer program products according to the invention. It will be understood that each block or step of the flowchart and screen shot illustrations, and combinations of blocks in the flowchart and screen shot illustrations, can be implemented by computer program instructions or other means, such as operator interaction. Although computer program instructions are discussed herein below, for example, an apparatus according to the present invention can include other means, such as hardware or some combination of hardware and software, including one or more processors or controllers for inputting the script, linking together information components, or transferring linked information components to storage.

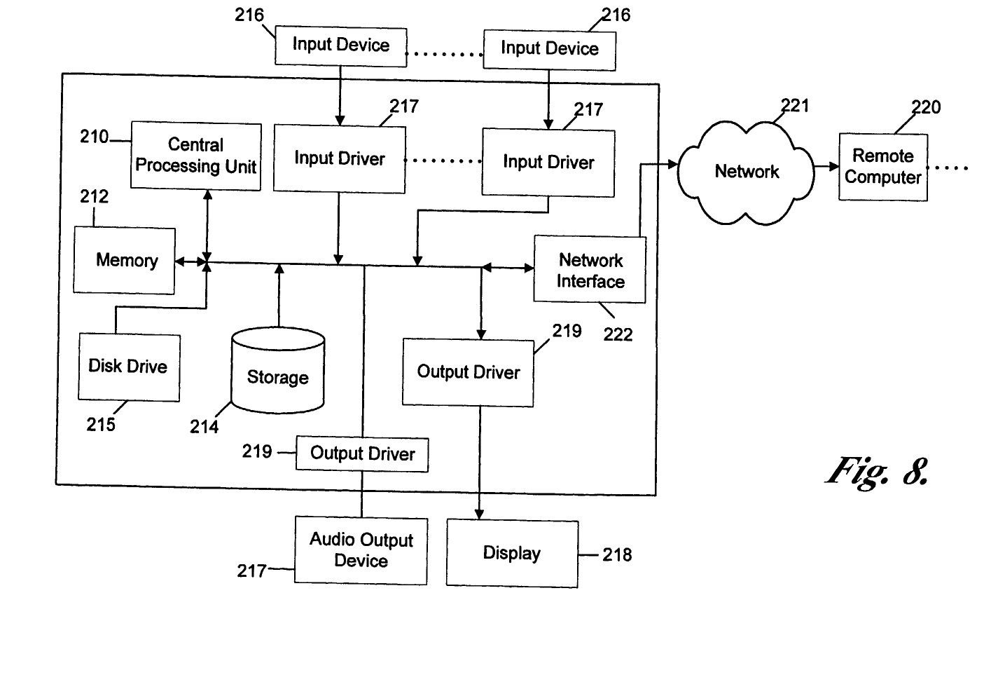

In this regard, FIG. 8 depicts the apparatus of one exemplary host embodiment including several of the key components of a general-purpose computer 200 on which the electronic book may be created. Those of ordinary skill in the art will appreciate that a computer includes many more components than those shown in FIG. 8. However, it is not necessary that all of these generally conventional components be shown in order to disclose an illustrative embodiment for practicing the invention. The computer 200 includes a processing unit 210 and a memory 212, which suitably includes random access memory (RAM) and read-only memory (ROM) of any acceptable variant. The computer 200 also includes storage 214, such as a hard disk drive, where data, such as the information components and applications may be stored. The apparatus of the present invention can also include one or more input devices 216, such as a mouse, keyboard, a scanner, a microphone, audio devices, graphic devices, a camera, or a video camera, etc, that are connected to input drivers 217 that are included in the computer 200 for inputting data. In one embodiment, one of the input drivers 217 suitably includes a voice recognition module for enabling users to dictate into the electronic book, thereby customizing the book to the user's needs. A display 218 is provided for displaying graphics data and visual elements, and interacting with a user interface to input visual elements. The display 218 is connected to an output driver 219 that is included in the computer 200. The computer 200 also suitably includes an audio output device 217, such as a speaker, a speaker system, or a headphone or earphone, that is connected or connectable to another output driver 219. The audio output device 217 permits the user to monitor audio elements while interacting with a user interface to input the audio elements. The computer 200 also includes means, such as a disk drive 215, for transferring the electronic book to a portable storage medium, such as a compact disk (CD), a floppy disk, a FLASH memory module, a zip disk, or the like. The means for transferring the electronic book to one or more remote computers 220, such as a server, through a network 221 for future download may also suitably include a network interface 222 for transferring the electronic book. The network 221 suitably includes a local area network (LAN), a wide area network (WAN), an intranet, an extranet, or the Internet. As is known, the network interface 222 includes all of the necessary circuitry for such a connection to the network 221.

Typically, computer program instructions may be loaded onto the computer or other programmable apparatus to produce a machine, such that the instructions which execute on the computer or other programmable apparatus create means for implementing the functions specified in the flowcharts or screen shot block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart or screen shot block(s) or step(s). The computer program instructions may also be loaded onto the computer or other programmable apparatus to cause a series of operational steps to be performed on the computer or other programmable apparatus to produce a computer implemented process such that the instructions which execute on the computer or other programmable apparatus provide steps for implementing the functions specified in the flowchart or screen shot block(s) or step(s).

Accordingly, blocks or steps of the flowchart or screen shot illustrations support combinations of means for performing the specified functions and program instruction means for performing the specified functions. It will also be understood that each block or step of the flowchart or screen shot illustrations, and combinations of blocks or steps in the flowchart or screen shot illustrations, can be implemented by special purpose hardware-based computer systems which perform the specified functions or steps, or combinations of special purpose hardware and computer instructions.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

what is claimed is:

1. A method of creating a multimedia electronic book, the method comprising:
developing information components of an electronic book;
linking together the information components; and
transferring the linked information components to storage in at least one predetermined playing format.

2. The method of claim 1, wherein developing information components includes creating a script.

3. The method of claim 2, wherein creating the script creates at least one of text of the book, descriptions of visual elements of the book, and descriptions of audio elements of the book.

4. The method of claim 3, further comprising corresponding the text with at least one of the visual elements and the audio elements.

5. The method of claim 3, further comprising inputting the script.

6. The method of claim 5, wherein inputting the script includes inputting the text.

7. The method of claim 6, wherein inputting the script further includes creating the visual elements.

8. The method of claim 7, wherein creating the visual elements includes creating at least one of video, photographs, animation, and graphics images.

9. The method of claim 6, wherein inputting the script further includes recording the audio elements.

10. The method of claim 9, wherein recording the audio elements includes recording at least one of narration, music, and sound effects.

11. The method of claim 7,wherein linking together the information components synchronizes together the text and the visual elements.

12. The method of claim 9, wherein linking together the information components includes synchronizing together the text and the audio elements.

13. The method of claim 1, wherein linking together includes linear synchronized linking.

14. The method of claim 1, wherein linking together includes non-linear indexed linking.

15. The method of claim 1, wherein transferring includes transferring the linked information components to a portable storage medium.

16. The method of claim 1, wherein transferring includes transferring the linked information components to a server.

17. A system for creating a multimedia electronic book, the system comprising:
an input device for inputting information components of a multimedia electronic book;
a processor arranged to link together the information components; and
means for transferring the linked information components to a storage device.

18. The system of claim 17, further comprising a voice-recognition module arranged to receive and process dictation of a user.

19. The system of claim 17, wherein the input device is further arranged to input at least one of text of the book, visual elements, and audio elements.

20. The system of claim 17, wherein the transferring means includes a disk drive.

21. The system of claim 17, wherein the transferring means includes a network interface.

22. A computer program product for permitting a user to navigate a multimedia electronic book on electronic equipment, the computer program product comprising:
first computer-readable program code of text of an electronic book;
second computer-readable program code of multimedia components of the electronic book; and
third computer-readable program code means for linking together the first and second computer-readable program code.

23. The computer program product of claim 22, wherein the multimedia components include visual elements.

24. The computer program product of claim 23, wherein the visual elements include at least one of text animation, highlighting, video, 3D graphics, and still images.

25. The computer program product of claim 22, wherein the multimedia components include audio elements.

26. The computer program product of claim 25, wherein the audio elements include at least one of music, speech, and sound effects.

27. The computer program product of claim 22, further comprising fourth computer-readable program code means for linking the text to the World Wide Web.

28. The computer program product of claim 22 further comprising fifth computer-readable program code means for linking the text to a glossary.

29. The computer program product of claim 22, further comprising sixth computer-readable program code means for linking the text to a glossary.
